(19) United States
(12) Patent Application Publication
(10) Pub. No.: US 2006/0184726 A1
(43) Pub. Date: Aug. 17, 2006

(54) Flexible access and control of Dynamic Random Access Memory

(75) Inventors: Jani Klint, Tampere (FI); Matti Floman, Kangasala (FI); Jukka-Pekka Vihmalo, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/057,063

(22) Filed: Feb. 11, 2005

(51) Int. Cl. G06F 12/00

(52) U.S. Cl. 711/105

(57) ABSTRACT

The invention relates in general to a method for accessing data stored in a dynamic random access memory. To enable flexible use of different types of memory modules, the invention provides addressing data through at least one address bus, controlling at least data flow to and from the dynamic random access memory through at least one control bus, transferring data to and from the dynamic random access memory through at least one data bus, and clocking the dynamic random access memory through at least one clock input, wherein transferring data to and from the dynamic random access memory through the data bus is operated at a variable data flow rate such that the number of data bits transferred on the data bus within one clock cycle is adjustable through at least one command on the control bus.

### FIELD OF THE INVENTION

The invention relates in general to accessing a Dynamic Random Access Memory (DRAM)

### BACKGROUND OF THE INVENTION

Memory technology implies the need for accessing data within memory devices, such as DRAM or other memory devices. Therefore, different addressing strategies have already been proposed.

A possible feature of DRAMs is address multiplexing. This technique enables splitting the address in half and feeding each half in turn to the chip on the address bus pins.

The chip has a large array of memory capacitors that are arranged in rows and columns. To read one location in the array, the control circuit first calculates its row number, which it places on the DRAM's address pins. It then toggles the row address select (RAS) pin, causing the DRAM to read the row address. Internally, the DRAM connects the selected row to a bank of amplifiers called sense amplifiers, which read the contents of all the capacitors in the row. The control circuit then places the column number of the desired location on the same address pins, and toggles the column address select (CAS) pin, causing the DRAM to read the column address. The DRAM uses this to select the output of the sense amplifier corresponding to the selected column. After a delay called the CAS access time, this output is presented to the outside world on the DRAM's data I/O pin.

To write data to the DRAM, the control logic uses the same two-step addressing method, but instead of reading the data from the chip at the end of the operation, it provides data to the chip at the start of the operation.

After a read or write operation, the control circuit returns the RAS and CAS pins to their original states to ready the DRAM for its next operation. The DRAM requires a certain interval called the precharge interval between operations.

Once the control circuit has selected a particular row, it can select several columns in succession by placing different column addresses on the address pins, toggling CAS each time, while the DRAM keeps the same row activated. This is quicker than accessing each location using the full row-column procedure. This method is useful for retrieving microprocessor instructions, which tend to be stored at successive addresses in memory.

In addition, the provision of commands is typically provided through command strobes on the command bus. The number of different commands depends on the number of pins on the command bus with 2^{N} and N the number of pins at the command bus. With the increasing demand for different commands, the command bus needed to be expanded. However, as die size is a crucial factor in application specific integrated circuit (ASIC) design, the number of pins on the command bus needs to be decreased.

Further, the size of the address bus is also relevant for the overall size of the connection interface between the memory device and the central processing unit (CPU). The higher data rates were required the higher the number of connection pins on the address bus were selected. This increased the size of the interface. In addition, the number of pins on the data bus and the overall number of pins of the interface determined the type of memory to be used on the interface, besides protocol issues. However, the demand for flexibility of usage of different kinds of memory devices was not accounted for. There is a need for a flexible interface which enables the use of different kinds of memory devices with different kinds of capabilities in terms of data throughput on the data bus.

The number of pins at the address bus, the data bus and the command bus is getting more critical, since new application designs require flexible and high bandwidth access to the memory devices. Doubling the bandwidth of the address bus would require doubling the number of address terminals. As the package size of memory devices is required to be small, increasing the number of pins is hardly to implement.

### SUMMARY OF THE INVENTION

According to an aspect of the invention, the number of pins on an interface can be reduced and the flexibility of the interface increased by a method for accessing data stored in a dynamic random access memory, with addressing data through at least one address bus, controlling at least data flow to and from the dynamic random access memory through at least one control bus, transferring data to and from the dynamic random access memory through at least one data bus, and clocking the dynamic random access memory through at least one clock input, wherein transferring data to and from the dynamic random access memory through the data bus is operated at a variable data flow rate such that the number of data bits transferred on the data bus within one clock cycle is adjustable through at least one command on the control bus.

According to another aspect, the objects are also solved by an interface for interfacing between an integrated circuit and a Dynamic Random Access Memory comprising address bus pins for addressing data, control bus pins for controlling at least data flow to and from the dynamic random access memory, data bus pins for transferring data to and from the dynamic random access memory, and clock pins for providing clocking signals to the dynamic random access memory, the interface is arranged to vary the data flow rate on the data bus pins for transferring data to and from the dynamic random access memory such that the number of data bits transferred on the data bus within one clock cycle is adjustable through at least one command on the control bus. The integrated circuit can be a central processing unit (CPU) or an application specific integrated circuit (ASIC) or any other integrated circuit.

One other aspect of the invention is an integrated circuit comprising an interface for connection Dynamic Random Access Memories with the integrated circuits comprising address bus pins for addressing data, control bus pins for controlling at least data flow to and from the dynamic random access memory, data bus pins for transferring data to and from the dynamic random access memory, and clock pins for providing clocking signals to the dynamic random access memory, the interface is arranged to vary the data flow rate on the data bus pins for transferring data to and from the dynamic random access memory such that the number of data bits transferred on the data bus within one clock cycle is adjustable through at least one command on the control bus. The integrated circuit can be an ASIC a CPU or any other integrated circuit.

A further aspect of the invention is a dynamic random access memory with address bus pins for addressing data, control bus pins for controlling at least data flow, data bus pins for transferring data, and clock pins for providing clocking signals to the dynamic random access memory, the memory is arranged to vary the data flow rate on the data bus pins for transferring data such that the number of data bits transferred on the data bus within one clock cycle is adjustable through at least one command on the control bus.

A further aspect of the invention is a computer program product with a computer program stored thereon for providing transferring data between a Dynamic Random Access Memory and an application specific integrated circuit such that the data flow rate of a data bus for transferring data to and from the dynamic random access memory is varied such that the number of data bits transferred on the data bus within one clock cycle is adjustable through at least one command on a control bus.

Another aspect of the invention is a mobile communication device with an integrated circuit (IC) and a Dynamic Random Access Memory comprising an interface for interfacing between the IC and the Dynamic Random Access Memory comprising address bus pins for addressing data, control bus pins for controlling at least data flow to and from the dynamic random access memory, data bus pins for transferring data to and from the dynamic random access memory, and clock pins for providing clocking signals to the dynamic random access memory, the interface is arranged to vary the data flow rate on the data bus pins for transferring data to and from the dynamic random access memory such that the number of data bits transferred on the data bus within one clock cycle is adjustable through at least one command on the control bus. The IC can be an ASIC a CPU or any other integrated circuit.

### BRIEF DESCRIPTION OF THE DRAWINGS

In the drawings show:

FIG. 1 a simplified block diagram of a central processing unit coupled to a memory unit through a bus, where the bus includes a plurality of command signal lines, address signal lines, clock signal lines, and control signal lines.

FIG. 2 a table with different command to be transferred on the command sub-bus, according to one embodiment;

FIG. 3 a flowchart of an inventive method, according to embodiments;

FIG. 4 a timing chart of an memory addressing;

FIG. 5 a consumer electronic device using the method and memory device according to embodiments;

### DETAILED DESCRIPTION

By way of introduction, the embodiments of this invention reduce a number of IC pins needed for connecting an integrated circuit, such as a memory integrated circuit, such as a dynamic RAM (DRAM), to other circuitry, such as baseband circuitry in a portable wireless communications terminal. In addition, by way of the flexible provision of data flow rates on the data bus and bus width, different types of memory devices can be supported by an interface according to embodiments.

The embodiments of this invention provide a novel technique for providing control and addressing data on a bus to the memory device by providing differential data structures on the buses. For example, the data bus width and the data flow rate on the data bus can be changed dynamically. The change of data bus width and/or data flow rate can be done by a mode register set (MRS) cycle indicating to a special register the corresponding settings through the control bus. Further, for example differential clock timing, differential strobe timing, differential clock frequency, and reliability with optional DLL can be provided. By using DLL the reliability and processing speed of a DRAM can be improved. In addition, the values for setting the flexible bus configuration can, for example, be stored by providing a special register storing differential timing data. The register fields of the special register can be used in the same way as any register fields via an MRS cycle.

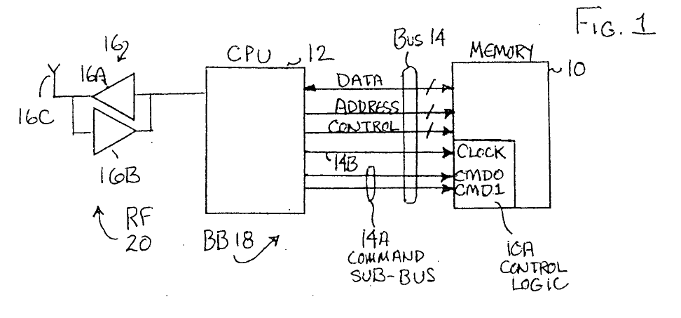

FIG. 1 is a simplified block diagram of a memory unit 10 coupled to a central processing unit (CPU) 12 through a bus 14. In addition to conventional bidirectional data signal lines, address signal lines, and control signal lines (such as, for example, a read/write signal line) The bus includes a command sub bus 14A and a clock signal line 14B. For the case where the memory unit 10 is located in an IC separate from the CPU 12, each of the bus 14 signal lines needs to be connected to the memory unit 10 via an IC pin or terminal. In other embodiments the memory unit 10 and the CPU 12 may be integrated on, or otherwise combined within, the same IC package. However, in this case the bus 14 still interfaces to the memory unit 10.

Note that certain of the signals lines could be placed in an optional control bus.

The buses can be the control, address and data (includes data strobes) buses shown in FIG. 1. Clock signal(s) are not typically referred to as a bus. In traditional memories there is a single clock signal, but in more advanced memories a differential clock is used, which requires two signal lines.

The interface 14 between the CPU and the memory device can be configured by the address bus for addressing data, the control bus for controlling at least data flow to and from the dynamic random access memory, the data bus for transferring data to and from the dynamic random access memory, and the clock 14B for providing clocking signals to the dynamic random access memory. The control bus can be extended by command sub-bus 14A.

The interface 14 can use traditional signalling for the control bus, for example, via the LVCMOS protocol. The signalling on the data bus can be differential, with varying data bus width and data flow rate, though. However, differential signalling can also be used on all buses.

The interface 14 can be arranged to vary the data flow rate on the data bus for transferring data to and from the dynamic random access memory 10. The interface can receive on the control bus instructions to vary the data flow rate such that the number of data bits transferred on the data bus within one clock cycle is adjustable through at least one command on the control bus. The data flow rate can be stored in a special register of the DRAM 10.

The data bus width on the data bus can be changed to, for example, x2, x4, x8, x16, etc. These values can be provided on the control bus. The values can be stored in a special register. The numbers x4, x8, etc, can be understood as the number of data signals on the data bus. The amount of data can increase with the number of data lines on the data bus, e.g., the bus width.

The described interface allows connecting different types of memory 10 to the CPU, where the capabilities of the memory can be accounted for through setting the data flow rate and the data bus width accordingly. Low end systems can be operated with low pin count and low data rate, whereas high end systems can be operated with a higher data rate,

Logistic benefit can be received if the used memory components for low and high end are the same, which is a reason for flexible set up. Another option can be that the memory components are predefined to work with certain maximum values. The host interface can check the settings from the memory and can set its own parameters accordingly. In this case the interface is flexible, but the memory component is not.

The data cycles per clock and the burst length can be set through MRS cycles, for example. The values can be set separately. One MRS cycle can be used to configure the burst length and one MRS cycle can be used to configure the data cycles per clock.

The clock frequency on clock 14B can also vary. For example values between 1 MHz and 266 MHz are possible. With digital locked loops (dll) option in the memory 10 activated, the clock and strobes can be kept synchronized. The dll can be stabilizes with additional clocks when the clock frequency changes dynamically.

For a case where memory unit 10 and CPU 12 form a part of a communications terminal, such as a cellular telephone, there may also be a wireless section, such as a radio frequency (RF) transceiver 16 having an RF transmitter 16A and an RF receiver 16B for coupling to at least one antenna 16C. In this case the memory 10 and the CPU 12 may be considered to form a part of a baseband (BB) section 18 of the communications terminal, as opposed to an RF section 20. Note that in this embodiment the CPU 12 may be, or may be coupled to, a digital signal processor (DSP) or equivalent high speed processing logic.

In general, the various embodiments of a device wherein the circuit constructed and operated in accordance with this invention can be located include, but are not limited to, cellular telephones, personal digital assistants (PDAs) having or not having wireless communication capabilities, portable computers having or not having wireless communication capabilities, image capture devices such as digital cameras having or not having wireless communication capabilities, gaming devices having or not having wireless communication capabilities, music storage and playback appliances having or not having wireless communication capabilities, Internet appliances permitting wireless or wired Internet access and browsing, as well as portable units, terminals and devices that incorporate combinations of such functions.

Note in the embodiment of FIG. 1 that the command sub bus 14A includes two signal lines, labelled CMD0 and CMD1. There can also be more than two signal lines on command sub bus 14A. The circuit can operate with n consecutive edge transitions of the clock signal on the sub-command bus, where n>=2.

The state of each command sub bus 14B signal line can be sampled twice per clock pulse, once on the rising edge and once on the falling edge. This yields two signal line states per clock pulse, and an ability to encode up to 16 individual commands using two command signal lines in the command sub bus 14A. Note that the clock edge sampling could be arranged so that the falling edge was used first to sample CMD0 and CMD1, followed by the next rising edge. In either case two consecutive clock edges are used to sample the state or level of at least one other signal line to determine the information that is encoded by the level(s) of the at least one other signal line.

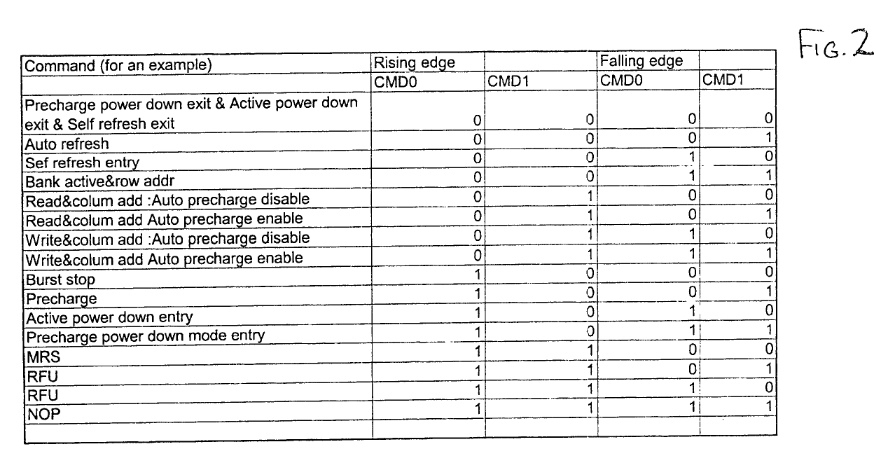

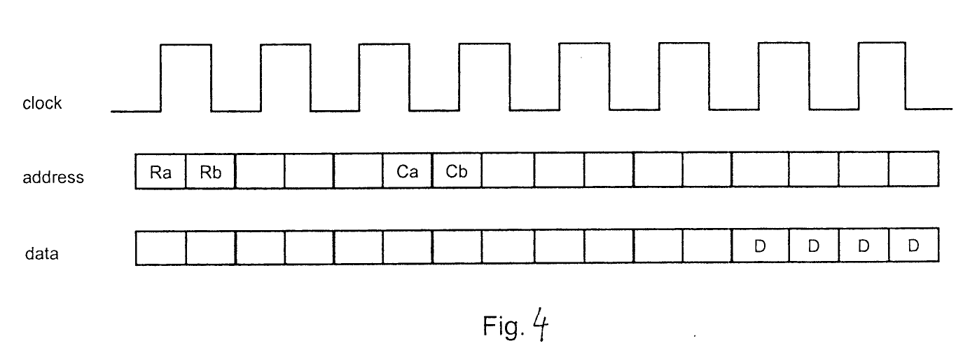

The advanced commands can be as illustrated in FIG. 2. For example and MRS cycle can be entered with CMD0 high (“1”) and CMD1 high (“1”) on the rising edge of the clock signal 14B, and CMD0 low (“0”) and CMD1 low (“0”) on the falling edge of the clock signal 14B. This sequence of four command signal line states (1100, as in FIG. 4) is interpreted by control logic 10A in the memory unit 10 as a receipt of the Mode Register Set (MRS) command. The MRS command allows entering in a mode register set command mode, where the setting for burst length, data cycles per clock, data bus width, etc can be configured.

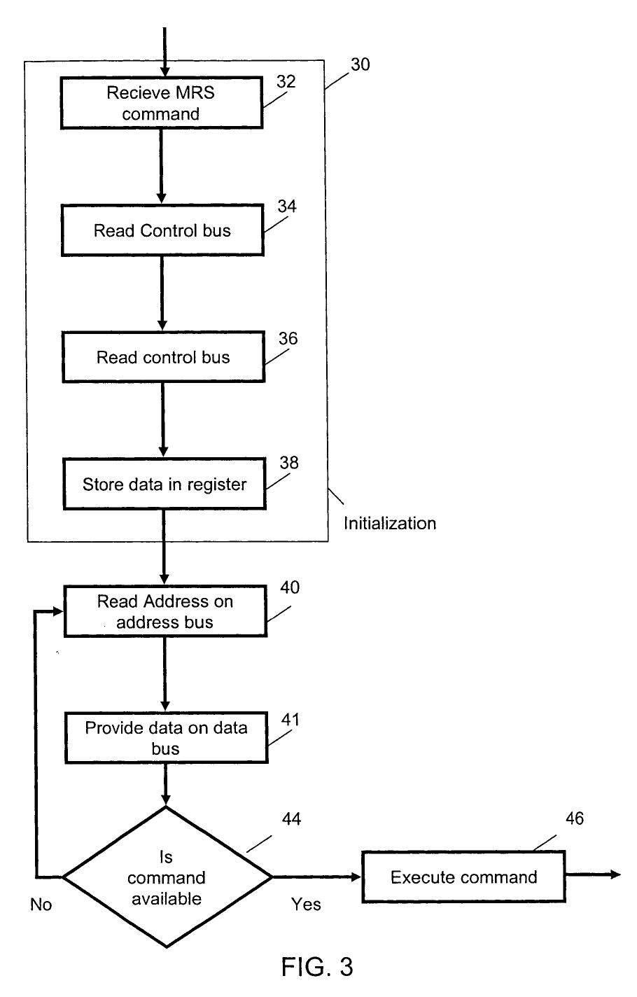

FIG. 3 illustrates a method according to embodiments for providing flexible setting of the interface for accessing memory, herein transferring data to and from the dynamic random access memory through the data bus is operated at a variable data flow rate such that the number of data bits transferred on the data bus within one clock cycle is adjustable through at least one command on the control bus. The MRS cycles are used in one solution, since it already exist. However there is no technical limitation for implementing new cycles on the control bus.

In an initialization phase 30, the values for data bus width and data flow rate, and possibly other flexible values are set. The memory 10 can receive on command sub-bus 14B an MRS command 32. The MRS command initiates an MRS cycle, where the necessary data is transferred from the CPU 12 to the memory 10. These data can be the data flow rate and the data bus width. In addition, the burst length, the clocking frequency, the DLL and other setting can be transferred.

The control bus can be read 34 to obtain the value for the number of data cycles per clock. In a next cycle, the control bus can be read 36 to obtain the bus width. Both values can as well be obtained in one single MRS cycle.

These values can be set by the CPU or the ASIC and can correspond to the respective memory 10. In addition, the memory can have fixed settings for these values and can provide the ASCI via the interface with its properties. The ASCI can then communicate with the memory 10 in-line with these setting.

After the values for the settings have been exchanged, the values can be stored 38 in a special register (not shown) in the memory 10.

In addition, the clocking frequency on the clock 14A can vary. The clock frequency can be determined during initialization 30 of the memory 10. In addition, the clocking can be adjusted during operation of the memory 10.

After initialization, the address commands, as will be described in more detail in FIG. 4 can be read 40 and the data can be retrieved from the data bus 42 in accordance with the setting of the data flow rate and the data bus width.

After on data cycle, the command bus can be checked 44 whether a new command is available. If no, the next set of data can be read 40, 42. If yes, the corresponding command can be executed 46.

As depicted in FIG. 4, the row address R can be divided into two parts Rₐ, R_{b} and the column address C can also ne divided into two parts Cₐ, C_{b}. By dividing row address R into the parts Rₐ, R_{b} and column address C into the parts Cₐ, C_{b}, the number of pins at the address bus ADDRESS may be reduced by a factor of substantially two. In the depicted case, the number of parts N=2 and an exemplary address bus size ADR=13 results in the total number pins T according to an inventive embodiment as

$$T = ⌈ \frac{13}{2} ⌉ = 4$$

As can be seen from the timing chart at the beginning of the first rising edge the first part Rₐ of the row address R is provided. After that, at the temporarily following falling edge of the timing clock signal CLOCK or strobe(s), the second part R_{b} of the row address is provided. By that, with a latency of half a clock period, the complete row address R is provided. With a latency of two rising edges, the column address is provided within two parts, Cₐ, C_{b}.

As can be seen from FIG. 4, the first part Cₐ of column address C is provided at the first falling edge after the latency of two rising edges. The column address may, however, consist of more than two parts. In such a case, it is possible, according to embodiments, that a first part may already be delivered earlier than the first falling edge, after the latency of two rising edges. The only limit for delivering the column address earlier may be that the row address needs to be fully delivered.

The second part C_{b} of the column address C may then be provided at the temporarily consecutive rising edge. With the address information being divided into two parts, the row address R is provided with a latency of half a clock cycle and the column address C is provided at the same time as without division of the address information. The data is provided at the data bus at the same time as without division of address information. Column address C is not delayed with half a clock cycle, since the controller or the central processing unit may start sending column address C half a clock period earlier then in case of standard addressing, as addressing is already possible during a falling edge.

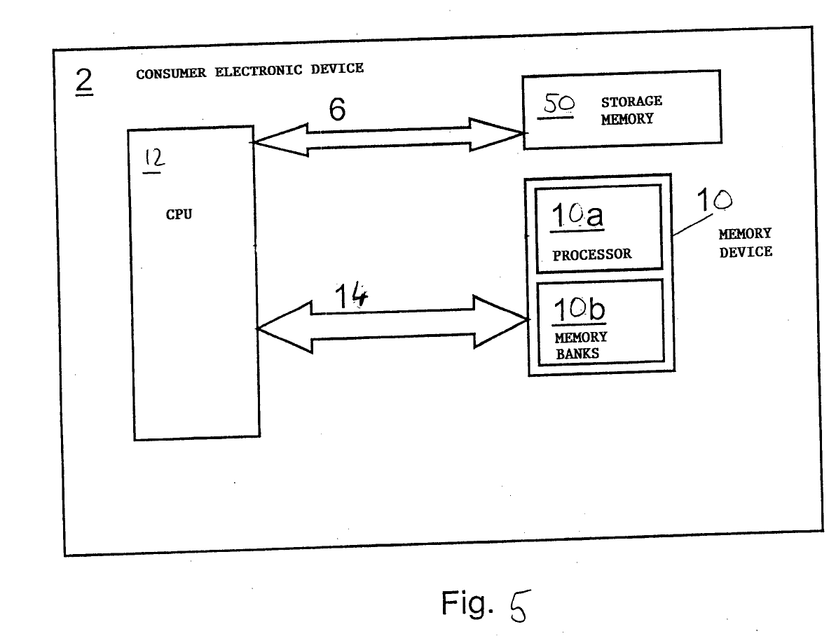

FIG. 5 depicts a consumer electronic device 2 comprising a central processing unit CPU 12, control and I/O bus 6 between CPU 12 and storage memory 50, bus 14, and memory device 10. Memory device 10 can comprise processing means 10a, and memory banks 10b, storing the actual data. The memory device 10 can be operated as described above through bus 14.

Storage memory 50, which may for example be a computer program product, such as a data carrier, may provide a computer program via I/O bus 6 to central processing unit 12 for retrieving data from memory device 10. The computer program comprises instructions for execution on at least one processor to transfer data between a Dynamic Random Access Memory 10 and an application specific integrated circuit 12 such that the data flow rate on a data bus for transferring data to and from the dynamic random access memory is varied such that the number of data bits transferred on the data bus within one clock cycle is adjustable through at least one command on a control bus 14.

What is claimed is:

1. A method for accessing data stored in a dynamic random access memory, comprising the steps of:
addressing data through at least one address bus,
controlling at least data flow to and from the dynamic random access memory through at least one control bus,
transferring data to and from the dynamic random access memory through at least one data bus, and
clocking the dynamic random access memory through at least one clock input,
wherein transferring data to and from the dynamic random access memory through the data bus is operated at a variable data flow rate such that the number of data bits transferred on the data bus within one clock cycle is adjustable through at least one command on the control bus.

2. The method of claim 1, further comprising clocking the dynamic random access memory with variable clock frequency at the clock input.

3. The method of claim 2, wherein the clock frequency is determined during initialization of the Dynamic Random Access Memory.

4. The method of claim 2, wherein the clock frequency is varied during operation of the Dynamic Random Access Memory.

5. The method of claim 1, further comprising varying the data bus width on the data bus to x2ⁿ, with n a positive integer.

6. The method of claim 1, further comprising storing at least one of
A) the data flow rate; and
B) the data bus width
within at least one special register of the Dynamic Random Access Memory.

7. The method of claim 1, further comprising providing addressing on the address bus on a falling edge and on a rising edge of a clock signal.

8. The method of claim 1, further comprising providing commands on the command bus within a rising and falling edge.

9. The method of claim 1, further comprising providing addressing on the address bus with a variable burst length.

10. The method of claim 1, further comprising providing data transfer on the data bus with a variable burst length.

11. An interface for interfacing between an integrated circuit and a Dynamic Random Access Memory comprising
address bus pins for addressing data,
control bus pins for controlling at least data flow to and from the dynamic random access memory,
data bus pins for transferring data to and from the dynamic random access memory, and
clock pins for providing clocking signals to the dynamic random access memory,
wherein the interface is arranged to vary the data flow rate on the data bus pins for transferring data to and from the dynamic random access memory such that the number of data bits transferred on the data bus within one clock cycle is adjustable through at least one command on the control bus.

12. The interface of claim 11, further comprising varying the data bus width on the data bus to x2ⁿ, with n a positive integer.

13. The interface of claim 11, further arranged for supporting different types of Dynamic Random Access Memory through variable selection of data bus width and data flow rate on the address bus and the data bus.

14. The interface of claim 11, further comprising varying the clocking frequency on the clock pin.

15. The integrated circuit comprising an interface of claim 11.

16. The integrated circuit of claim 15, further comprising varying the data width on the data bus to x2ⁿ, with n a positive integer.

17. The integrated circuit of claim 15, further arranged for supporting different types of Dynamic Random Access Memory through variable selection of bus width and data flow rate on the address bus and the data bus.

18. The integrated circuit of claim 15, further comprising varying the clocking signal on the clock pin.

19. A dynamic random access memory comprising:
address bus pins for addressing data,
control bus pins for controlling at least data flow,
data bus pins for transferring data, and
clock pins for providing clocking signals to the dynamic random access memory,
wherein the memory is arranged to vary the data flow rate on the data bus pins for transferring data such that the number of data bits transferred on the data bus within one clock cycle is adjustable through at least one command on the control bus.

20. The dynamic random access memory of claim 19, further comprising varying the data width on the data bus with x2ⁿ, with n a positive integer.

21. The dynamic random access memory of claim 19, further arranged for receiving a varying clocking signal on the clock pin.

22. The dynamic random access memory of claim 19, further comprising a special register for storing the data flow rate and the data bus width.

23. A computer-system comprising a central processing unit and a memory device, where the central processing unit is in connection with the memory device via an interface of claim 11.

24. A computer program product with a computer program stored thereon, the program comprising instruction for execution on at least one processor so as to operate said at least one processor to transfer data between a dynamic random access memory and an application specific integrated circuit such that the data flow rate a data bus for transferring data to and from the dynamic random access memory is varied such that the number of data bits transferred on the data bus within one clock cycle is adjustable through at least one command on a control bus.

25. A mobile communication device with a integrated circuit (IC) and a dynamic random access memory comprising an interface for interfacing between the IC and the dynamic random access memory comprising
address bus pins for addressing data,
control bus pins for controlling at least data flow to and from the dynamic random access memory,
data bus pins for transferring data to and from the dynamic random access memory, and
clock pins for providing clocking signals to the dynamic random access memory,
wherein the interface is arranged to vary the data flow rate on the data bus pins for transferring data to and from the dynamic random access memory such that the number of data bits transferred on the data bus within one clock cycle is adjustable through at least one command on the control bus.
